(19) United States
(12) Patent Application Publication
(10) Pub. No.: US 2025/0058659 A1
(43) Pub. Date: Feb. 20, 2025

(54) Cover and Cover Assembly

(71) Applicant: Illinois Tool Works Inc., Glenview, IL (US)

(72) Inventor: Yuan SUN, Shanghai (CN)

(21) Appl. No.: 18/807,489

(22) Filed: Aug. 16, 2024

(30) Foreign Application Priority Data
Aug. 18, 2023 (CN) 202311050165.5

(51) Int. Cl. B60L 53/16

(52) U.S. Cl. CPC B60L 53/16

(57) ABSTRACT

Disclosed is a cover for sealing a charging port. The cover has a cover body with an inner cover side and an outer cover side facing away from each other. The cover body includes a first sealing portion and a second sealing portion. The first sealing portion to seal a first charging port and the second sealing portion to seal a second charging port. The first sealing portion and the second sealing portion are arranged in an outer peripheral direction of the cover body, and the first sealing portion and the second sealing portion are both arranged on the inner cover side of the cover body. The two sealing portions of the cover are arranged on the same side of the cover facing the charging ports, so that when the cover seals either of the charging ports, the two sealing portions are neither directly exposed to an external environment of a vehicle, thereby reducing the risk that the two sealing portions of the cover are contaminated by the external environment, and thus reducing the risk that the charging ports and charging interface elements inside the charging ports are contaminated.

### RELATED APPLICATION

The present application claims the benefit of Chinese Patent Application Nos. 202311050165.5, filed Aug. 18, 2023, titled “Cover and Cover Assembly,” the contents of which are hereby incorporated by reference.

### TECHNICAL FIELD

The present disclosure relates to a cover and a cover assembly, and in particular, to a cover and a cover assembly that are suitable for different diameters of charging ports on new energy vehicles.

### BACKGROUND

New energy vehicles need to be equipped with a charging socket, the charging socket typically has direct-current charging ports and alternating-current charging ports. In order to reduce costs, more and more vehicle enterprises use charging seats that include direct-current and alternating-current charging ports. When a new energy vehicle is charged outdoors, a charging seat cover on a vehicle body surface is opened first, thus exposing the charging ports. During charging, a charging gun only seals one charging port that is being charged, while the other charging port is exposed to an external environment. If it rains as the new energy vehicle is being charged, the charging port exposed to the external environment is at risk of water ingress, which may influence the performance of a charging connection device and pose a potential safety hazard. Since domestic direct-current and alternating-current charging ports are different in size, the above problem can be solved by providing two charging port covers to seal the direct-current charging port and the alternating-current charging port respectively, and it is required to remove one corresponding charging port cover when charging is in process.

### SUMMARY

The present disclosure relates generally to a cover for sealing a charging port, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1A is a perspective view of a charging assembly according to the present disclosure, in which a charging gun is about to be fitted with a direct-current interface.

FIG. 1B is a perspective view of the charging assembly according to the present disclosure, in which the charging gun is about to be fitted with an alternating-current interface.

FIG. 1C is an exploded view of the charging assembly shown in FIGS. 1A and 1B.

FIG. 2A is a perspective view of a cover according to the present disclosure.

FIG. 2B is a perspective view of the cover according to the present disclosure from another perspective.

FIG. 2C is a cross-sectional view of the cover according to the present disclosure taken along section line M-M in FIG. 2B.

FIG. 3A is a perspective view of the charging assembly according to the present disclosure, in which the cover is in an intermediate position during the switching of charging ports.

FIG. 3B is a top view of the charging assembly shown in FIG. 3A.

FIG. 3C is a simplified view of a four link-rods mechanism in the charging assembly shown in FIG. 3B.

FIG. 4A is a front view of a cover assembly according to the present disclosure, in which a cover is in a position where a direct-current charging port is sealed.

FIG. 4B is a cross-sectional view of the cover assembly according to the present disclosure taken along section line P-P in FIG. 4A.

FIG. 5A is a front view of the cover assembly according to the present disclosure, in which the cover is in a position where an alternating-current charging port is sealed.

FIG. 5B is a cross-sectional view of the cover assembly according to the present disclosure taken along section line Q-Q in FIG. 5A.

### DETAILED DESCRIPTION

Various specific implementations of the present disclosure will be described below with reference to the accompanying drawings which constitute part of the present disclosure, but does not limit the present disclosure. It should be understood that although the terms indicating directions, such as “upper”, “lower”, “left”, “right”, “front” and “rear” are used in the present disclosure to describe orientations of structural parts and elements in various examples of the present disclosure, these terms are used herein only for ease of illustration and are determined on the basis of the exemplary orientations shown in the accompanying drawings. Since the embodiments of the present disclosure can be arranged in different directions, these terms indicating directions are merely illustrative and should not be considered as limitations.

The term “comprise/include”, and derivatives thereof used in the present disclosure mean inclusion without limitation. Unless otherwise specified and limited, the terms “mounting”, “connecting” and “connection” should be understood broadly. For example, they may be a mechanical or electrical connection, internal communication between two elements, or a direct connection or indirect connection via an intermediate medium. For those of ordinary skills in the art, the specific meanings of the above terms can be understood according to specific cases. If possible, the same or similar reference signs used in the present disclosure refer to the same components.

Considering that sealing a direct-current charging port and an alternating-current charging port respectively by using two charging port covers increases the complexity of a charging operation, for example, each time the charging operation is performed, it is required to open a charging seat cover on a vehicle body surface, then open a corresponding charging port cover (a direct-current charging port cover or an alternating-current charging port cover), and a dual-purpose charging port cover can be designed, when a charging gun is aligned with one of the charging ports for charging, the dual-purpose charging port cover can seal the other unused charging port. Since the dual-purpose charging port cover is provided with a sealing portion having a corresponding outer diameter on two sides of the cover respectively, the dual-purpose charging port cover can be suitable for two different diameters of charging ports, such as an alternating-current charging port or a direct-current charging port.

However, since the two sealing portions of the above-mentioned dual-purpose charging port cover are respectively provided on the two sides of the cover, when the charging port cover seals one of the charging ports (e.g., the direct-current charging port), the scaling portion for sealing the other charging port (e.g., the alternating-current charging port) is exposed, such that during the charging operation, the other sealing portion (e.g., the sealing portion for sealing the alternating-current charging port) is more likely to be contaminated by an external environment (dust, rain, and so on). If the other charging port (e.g., the alternating-current charging port) is sealed by using the contaminated sealing portion (e.g., the sealing portion that seals the alternating-current charging port), the charging port (e.g., the alternating-current charging port) is contaminated, and thus electrical components (such as a socket, and so on) inside the charging port are contaminated.

In addition, in the prior art, the removal of charging port covers, or the sealing of charging ports requires a manual operation, so that contaminations on the user's hand also contaminate scaling portions of the charging ports during the above-mentioned operation, and thus contaminate electrical components inside the charging ports. Meanwhile, manually touching the charging port covers may also pose a risk of electric shock.

On the basis of the above technical problems existing in the prior art, the present disclosure provides a charging port cover that can be configured to seal two different diameters of charging ports. Two sealing portions of the charging port cover are arranged on the same side of the cover. In use, the two sealing portions both face an inner side of the charging port, and neither of the sealing portions is exposed to the outside of the charging port, so that the possibility of the sealing portions being contaminated is reduced. The charging port cover of the present disclosure is movably connected to a charging seat by means of a four link-rods mechanism, the side where the sealing portions of the charging port cover are located always remains facing the inner side of the charging port during the switching of the charging port cover from one charging port to the other charging port, and thus the possibility that the sealing portions are contaminated in the use process of switching the charging ports of the charging port cover is reduced. Moreover, the present disclosure moves the charging port cover under the drive of the four link-rods mechanism by means of electric motor, avoiding a manual direct operation on the charging port cover to switch and seal the charging ports, which not only eliminates the possibility of electric shock to the human body, but also further improves the controllability of switching the charging ports from the charging port cover, and the charging port cover can meet the needs of integrated control of new energy vehicles in the future.

Therefore, according to a first aspect of the present disclosure, a cover for scaling a charging port is provided. The cover comprises: a cover body having an inner cover side and an outer cover side facing away from each other, the cover body comprising: a first sealing portion and a second sealing portion, the first sealing portion being configured to seal a first charging port; and the second sealing portion being configured to seal a second charging port; wherein the first sealing portion and the second sealing portion are arranged in an outer peripheral direction of the cover body, and the first sealing portion and the second sealing portion are both arranged on the inner cover side of the cover body.

According to the first aspect of the present disclosure, the first sealing portion and the second sealing portion are sequentially arranged in the outer peripheral direction of the cover body from the outer cover side to the inner cover side.

According to the first aspect of the present disclosure, the first sealing portion has a first outer diameter and is configured to seal the first charging port having a first aperture diameter; and the second sealing portion has a second outer diameter and is configured to seal the second charging port having a second aperture diameter.

According to the first aspect of the present disclosure, the first outer diameter of the first sealing portion is different from the second outer diameter of the second sealing portion, and the first aperture diameter of the first charging port is different from the second aperture diameter of the second charging port.

According to the first aspect of the present disclosure, the first sealing portion is different from the second sealing portion in shape, and the first charging port is different from the second charging port in shape.

According to the first aspect of the present disclosure, the cover further comprises: an upper cover pivot portion and a lower cover pivot portion, the upper cover pivot portion and the lower cover pivot portion being configured to connect the cover to a cover connection assembly; wherein the upper cover pivot portion has a first pivot axis, the lower cover pivot portion has a second pivot axis, and the cover connection assembly is pivotable relative to the cover about the first pivot axis or the second pivot axis.

According to the first aspect of the present disclosure, the first pivot axis and the second pivot axis are parallel to each other and do not coincide.

According to the first aspect of the present disclosure, the cover further comprises: a cover handle arranged on the outer cover side of the cover body.

According to the first aspect of the present disclosure, the cover handle comprises two hand-held recess portions recessed toward an inner side of the cover body for facilitating a user to hold the cover.

According to the first aspect of the present disclosure, an inner side end surface of the cover body has an inner side wall, and the cover further comprises a stop structure formed by protruding outward from the inner side wall.

According to the first aspect of the present disclosure, the first charging port is a direct-current charging port, and the second charging port is an alternating-current charging port.

According to the first aspect of the present disclosure, the cover is integrally made by means of cast molding.

According to a second aspect of the present disclosure, the cover assembly comprises: the cover as described in the first aspect of the present disclosure, a charging seat, and the cover connection assembly, the charging seat comprising the first charging port and the second charging port, and the cover connection assembly being configured to movably connect the cover to the charging seat, such that the cover switchably seals either of the first charging port and the second charging port.

According to the second aspect of the present disclosure, the aperture diameter of the first charging port is different from the aperture diameter of the second charging port.

According to the second aspect of the present disclosure, the first sealing portion is configured to be in interference fit with the first charging port so as to seal the first charging port, and the second sealing portion is configured to be in interference fit with the second charging port so as to seal the second charging port.

According to the second aspect of the present disclosure, the cover connection assembly comprises an upper link rod and a lower link rod, wherein the upper link rod has an upper link rod first end and an upper link rod second end, and the lower link rod has a lower link rod first end and a lower link rod second end; the cover comprises an upper cover pivot portion and a lower cover pivot portion; the charging seat comprises an upper pivot connecting portion and a lower pivot connecting portion; the upper link rod first end is pivotably connected to the upper cover pivot portion; the upper link rod second end is pivotably connected to the upper pivot connecting portion; the lower link rod first end is pivotably connected to the lower cover pivot portion; and the lower link rod second end is pivotably connected to the lower pivot connecting portion.

According to the second aspect of the present disclosure, the upper link rod first end is configured to pivot about a first pivot axis relative to the upper cover pivot portion, the lower link rod first end is configured to pivot about a second pivot axis relative to the lower cover pivot portion, the upper link rod second end is configured to pivot about a third pivot axis relative to the upper pivot connecting portion, and the lower link rod second end is configured to pivot about a fourth pivot axis relative to the lower pivot connecting portion.

According to the second aspect of the present disclosure, the first pivot axis, the second pivot axis, the third pivot axis and the fourth pivot axis are parallel to each other and do not coincide, a distance between the first pivot axis and the second pivot axis is the same as a distance between the third pivot axis and the fourth pivot axis, and the upper link rod and the lower link rod have the same length.

According to the second aspect of the present disclosure, the upper link rod, the lower link rod, the cover and the charging seat form a four link-rods mechanism.

According to the second aspect of the present disclosure, the cover assembly further comprises: an actuator configured to drive at least one of the upper link rod and the lower link rod to pivot.

According to the second aspect of the present disclosure, the cover assembly further comprises: a master control system, the actuator being communicably connected to the master control system, and the master control system being configured to drive the upper link rod or the lower link rod to pivot by controlling the actuator.

Some of the additional aspects and advantages of the present disclosure will be set forth in the following description, and some will become apparent from the following description, or be learned by practice of the present disclosure.

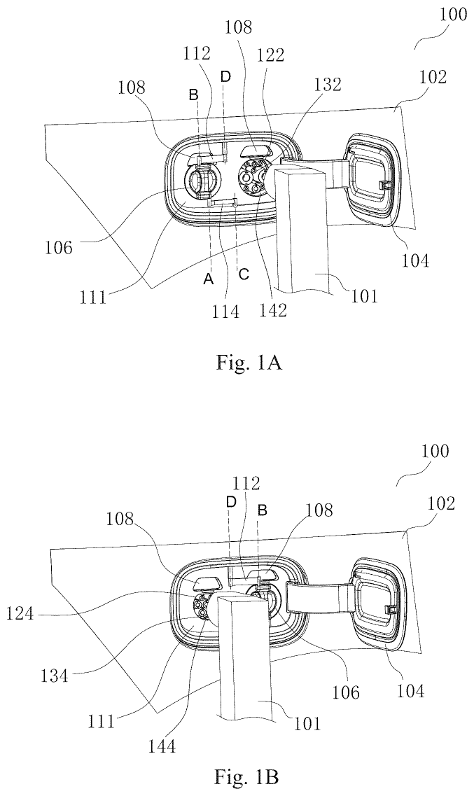

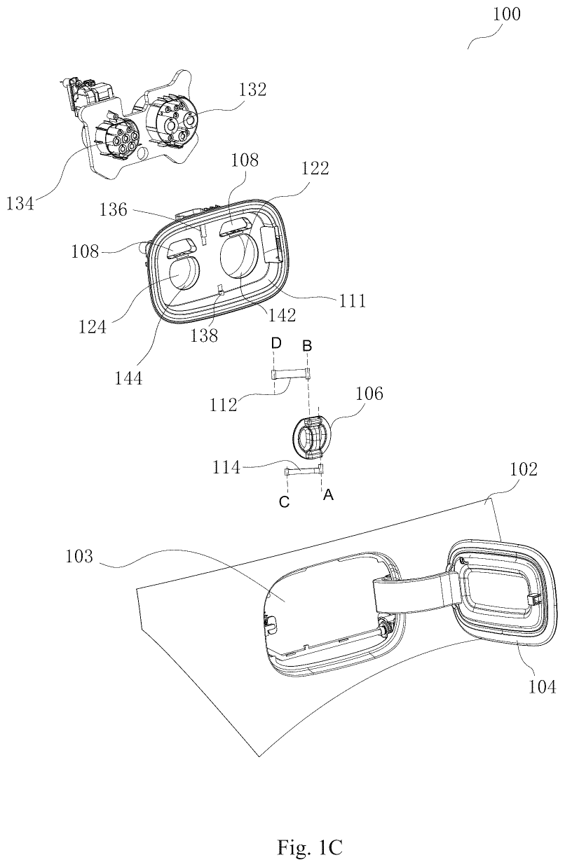

FIGS. 1A, 1B and 1C are perspective views of a charging assembly 100 of the present disclosure. FIG. 1A illustrates a use state in which a charging gun 101 is about to be fitted with a direct-current interface 132, FIG. 1B illustrates a use state in which the charging gun 101 is about to be fitted with an alternating-current interface 134, and FIG. 1C is an exploded view of a charging assembly 100 to illustrate a cooperation relationship of components in the charging assembly 100.

As shown in FIG. 1C, the charging assembly 100 of the present disclosure comprises a cover assembly, the direct-current interface 132 and the alternating-current interface 134, the cover assembly being arranged on an inner side of a vehicle body 102 of a new energy vehicle. Specifically, a charging seat opening 103 is formed in the vehicle body 102, the cover assembly is arranged on the inner side of the vehicle body at a corresponding position of the charging seat opening 103, and a charging seat cover 104 is provided in the vicinity of the charging seat opening 103 and configured to close the charging seat opening 103. FIGS. 1A, 1B and 1C illustrate schematic diagrams of the charging seat cover 104 in an open state, and when the charging seat cover 104 is closed, the charging seat cover 104 may be flush with a surface of the vehicle body 102.

In an embodiment of the present disclosure, the opening and closing of the charging seat cover 104 may be controlled by a master control system (not shown in the figures) of the vehicle. For those of skilled in the art, in some other embodiments, the opening and closing of the charging opening cover 104 may also be operated manually.

As shown in FIGS. 1A, 1B and 1C, the cover assembly comprises a cover 106, a charging seat 111, an upper link rod 112, and a lower link rod 114, wherein the upper link rod 112 and the lower link rod 114 have the same length and are configured to movably connect the cover 106 to the charging seat 111. Two charging ports are respectively provided in an inner side end surface of the charging seat 111 and penetrate through the charging seat. In an embodiment of the present disclosure, cross sections of the charging ports are substantially circular, the two charging ports are charging ports having different aperture diameters, that is, a direct-current charging port 122 and an alternating-current charging port 124, wherein the direct-current charging port 122 comprises a direct-current charging port inner wall 142 having a first diameter, the alternating-current charging port 124 comprises an alternating-current charging port inner wall 144 having a second diameter, and the cover 106 can be in interference fit with the direct-current charging port inner wall 142 and the alternating-current charging port inner wall 144 respectively, to seal the direct-current charging port 122 and the alternating-current charging port 124. In an embodiment of the present disclosure, the direct-current charging port inner wall 142 of the direct-current charging port 122 has an aperture diameter greater than the aperture diameter of the alternating-current charging port inner wall 144 of the alternating-current charging port 124. In some other embodiments, the aperture diameter of the direct-current charging port inner wall 142 may also be set to be less than the aperture diameter of the alternating-current charging port inner wall 144.

For those of ordinary skill in the art, in some other embodiments, the direct-current charging port 122 and the alternating-current charging port 124 may also be configured to have the same aperture diameter.

For those of ordinary skill in the art, in some other embodiments, the cross sections of the direct-current charging port 122 and the alternating-current charging port 124 may also be configured to have other shapes, such as an oval or a rectangle with rounded corners, and so on.

For those of ordinary skill in the art, in some other embodiments, the cross sections of the direct-current charging port 122 and the alternating-current charging port 124 may also be configured to have different shapes.

As shown in FIGS. 1A and 1B, the direct-current interface 132 can enter the direct-current charging port 122 and be partially received on the inner side of the direct-current charging port 122, and the alternating-current interface 134 can similarly enter the alternating-current charging port 124 and be partially received within the alternating-current charging port 124, such that the charging gun 101 can be engaged with and remain in electrical connection with the direct-current interface 132 by sequentially passing through the charging seat opening 103 and the direct-current charging port 122, or be engaged with and remain in electrical connection with the alternating-current interface 134 by sequentially passing through the charging seat opening 103 and the alternating-current charging port 124, from the outside of the vehicle body 102. A charging gun holding portion 108 is further provided above the direct-current charging port 122 and the alternating-current charging port 124 of the charging seat 111 respectively, and is configured to hold the charging gun 101 when the charging gun 101 is engaged with the direct-current interface 132 or the alternating-current interface 134, so that the charging gun 101 is prevented from accidentally falling off when the vehicle is being charged.

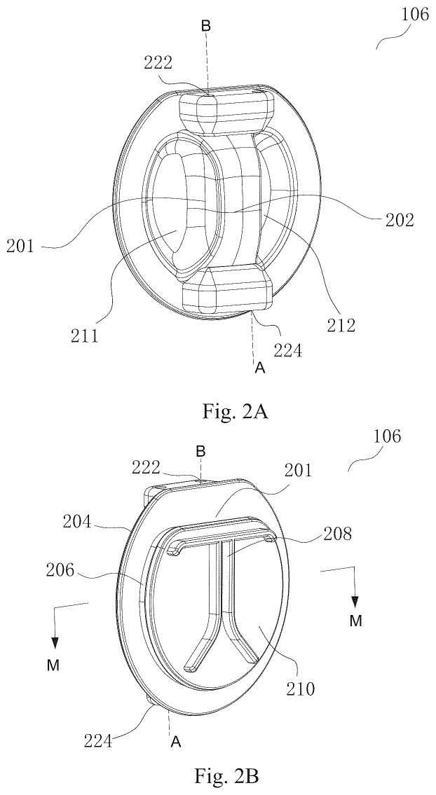

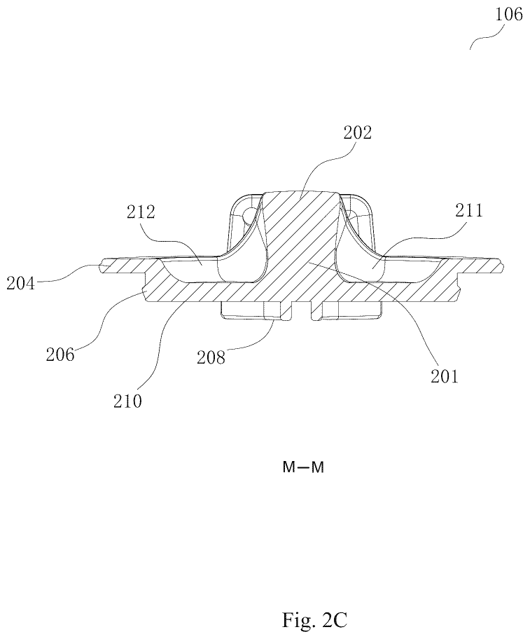

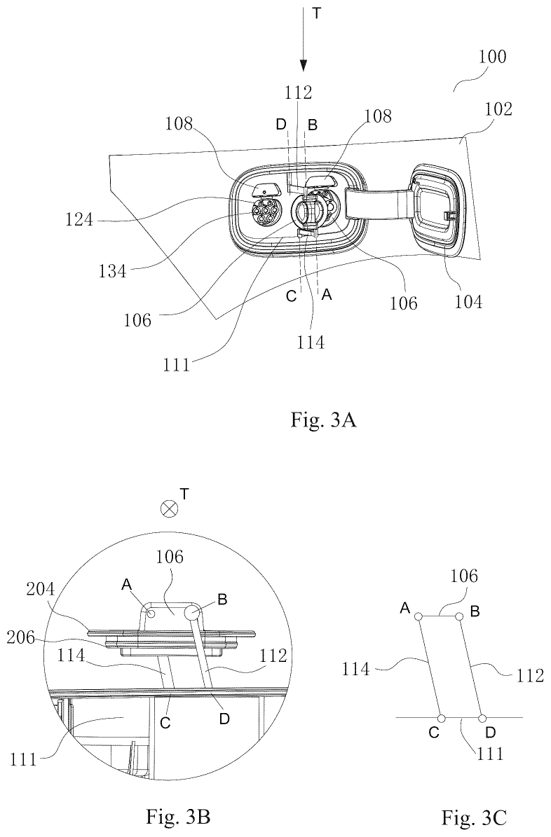

With continued reference to FIGS. 1A, 1B and 1C, the inner side end surface of the charging seat 111 is further provided with an upper pivot connecting portion 136 and a lower pivot connecting portion 138, the upper pivot connecting portion 136 is pivotably connected to one end of the upper link rod 112, the lower pivot connecting portion 138 is pivotably connected to one end of the lower link rod 114, and the other end of the upper link rod 112 and the other end of the lower link rod 114 away from the charging seat 111 are pivotably connected to an upper cover pivot portion 222 (see FIG. 2A) and a lower cover pivot portion 224 (see FIG. 2A) of the cover 106 respectively. The end of the upper link rod 112 connected to the upper pivot connecting portion 136 can swing back and forth about a pivot axis D, the end of the lower link rod 114 connected to the lower pivot connecting portion 138 can swing back and forth about a pivot axis C, the end of the upper link rod 112 connected to the upper cover pivot portion 222 can swing back and forth about a pivot axis B, and the end of the lower link rod 114 connected to the lower cover pivot portion 224 can swing back and forth about a pivot axis A. The pivot axis B and the pivot axis A run through the upper cover pivot portion 222 and the lower cover pivot portion 224 of the cover 106 respectively, and the pivot axis D and the pivot axis C run through the upper pivot connecting portion 136 and the lower pivot connecting portion 138 of the charging seat 111 respectively. The pivot axis A, the pivot axis B, the pivot axis C and the pivot axis D are parallel to each other and offset by a distance, such that the cover 106, the charging seat 111, the upper link rod 112 and the lower link rod 114 form a four link-rods mechanism (see illustrations in FIGS. 3A, 3B and 3C for details).

FIGS. 2A, 2B and 2C illustrate a specific structure of the cover 106 from multiple perspectives, wherein FIG. 2A illustrates a perspective view of the cover 106 viewed from the outer side of the charging port, FIG. 2B illustrates a perspective view of the cover 106 viewed from the inner side of the charging port, and FIG. 2C illustrates a cross-sectional view of the cover 106 taken along section line M-M in FIG. 2B.

As shown in FIGS. 2A and 2B, the cover 106 has a cover body 201, and the whole cover body 201 is in a disk shape and is integrally made by means of cast molding. The cover 106 is made of a soft plastic, such as TPE, so that the cover 106 is, when engaged with the charging port, in interference fit with the charging port inner wall by means of elastic deformation, so as to seal the charging port. When the cover 106 is inserted into the charging port, the sealed fixation to the charging port can be achieved by means of the interference fit with the charging port; and when the cover 106 is subjected to a pull force toward the outer side of the charging port, an interference fit part of the cover 106 can be out of the sealed fixation to the charging port by means of elastic deformation.

For ease of description, a side of the cover 106 viewed from the outer side of the charging port is defined below as the outer side of the cover, and a side of the cover 106 viewed from the inner side of the charging port is defined below as the inner side of the cover. The outer side and the inner side of the cover 106 are two sides of the cover 106 in opposite directions.

As shown in FIG. 2A, an outward side of the cover body 201 is provided with a cover handle 202 that comprises two hand-held recess portions 211, 212 recessed toward the inner side of the cover body 201 for facilitating user's fingers to hold the cover 106. The upper cover pivot portion 222 and the lower cover pivot portion 224 are provided on the upper side and the lower side of the cover handle 202 respectively, wherein the upper cover pivot portion 222 is pivotably connected to the upper link rod 112 together to be pivotable about the pivot axis B; and the lower cover pivot portion 224 is pivotably connected to the lower link rod 114 together to be pivotable about the pivot axis A. The pivot axis A and the pivot axis B are parallel to each other and are offset from each other by a certain distance in a transverse direction of the cover 106 in the figures.

As shown in FIGS. 2B and 2C, the other side (an inward side) of the cover body 201 relative to the cover handle 202 sequentially forms a direct-current sealing portion 204 and an alternating-current sealing portion 206 in an axial direction from outside to inside. In an embodiment of the present disclosure, cross sections of outer peripheral contours of the direct-current sealing portion 204 and the alternating-current sealing portion 206 are substantially circular. As shown in FIG. 2C, when viewed in a radial direction of the cover body 201, the direct-current sealing portion 204 and the alternating-current sealing portion 206 are arranged in a stepped manner, and are located in an outer peripheral direction of the cover body 201. The outer peripheral diameter of the direct-current sealing portion 204 is greater than the outer peripheral diameter of the alternating-current sealing portion 206. The direct-current sealing portion 204 is configured to seal the direct-current charging port 122, and the diameter thereof is slightly greater than the inner aperture diameter of the direct-current charging port 122, so that the direct-current sealing portion can be in interference fit with the direct-current charging port inner wall 142 and can be temporarily secured on the direct-current charging port 122. The alternating-current scaling portion 206 is configured to seal the alternating-current charging port 124, and the diameter thereof is slightly greater than the inner aperture of the alternating-current charging port 124, so that the alternating-current sealing portion can be in interference fit with the alternating-current charging port inner wall 144 and can be temporarily secured on the alternating-current charging port 124.

For those of ordinary skill in the art, in some other embodiments, since the direct-current charging port 122 and the alternating-current charging port 124 are also set to have the same aperture diameters, the outer diameter of the direct-current sealing portion 204 may also be set to be the same as the outer diameter of the alternating-current sealing portion 206.

For those of ordinary skill in the art, in some other embodiments, since the cross sections of the direct-current charging port 122 and the alternating-current charging port 124 may be configured to have other shapes, such as the oval or the rectangle with rounded corners, and so on, the outer peripheral contours of the direct-current sealing portion 204 and the alternating-current sealing portion 206 may also be set to have the shapes matching the cross sections of the direct-current charging port 122 and the alternating-current charging port 124.

For those of ordinary skill in the art, in some other embodiments, since the cross sections of the direct-current charging port 122 and the alternating-current charging port 124 may be configured to have different shapes, the outer peripheral contours of the direct-current scaling portion 204 and the alternating-current sealing portion 206 may also be configured to have different shapes to match the shapes of the cross sections of the direct-current charging port 122 and the alternating-current charging port 124.

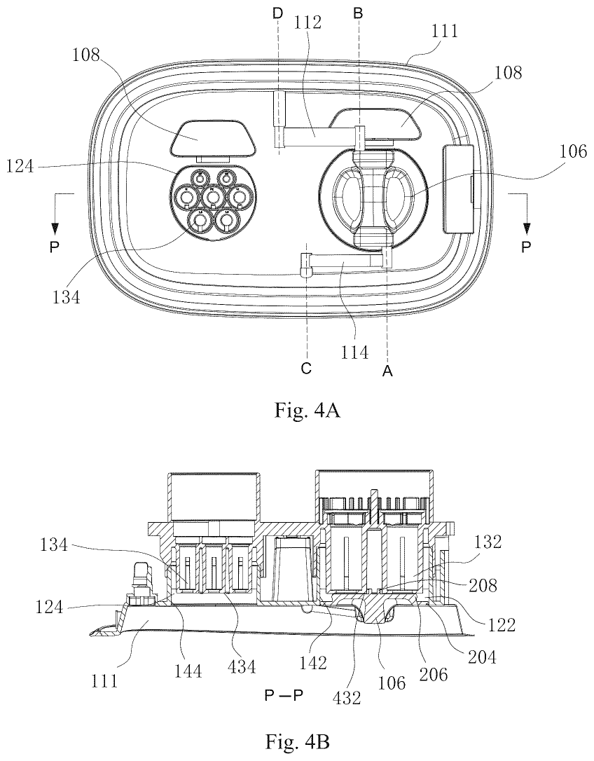

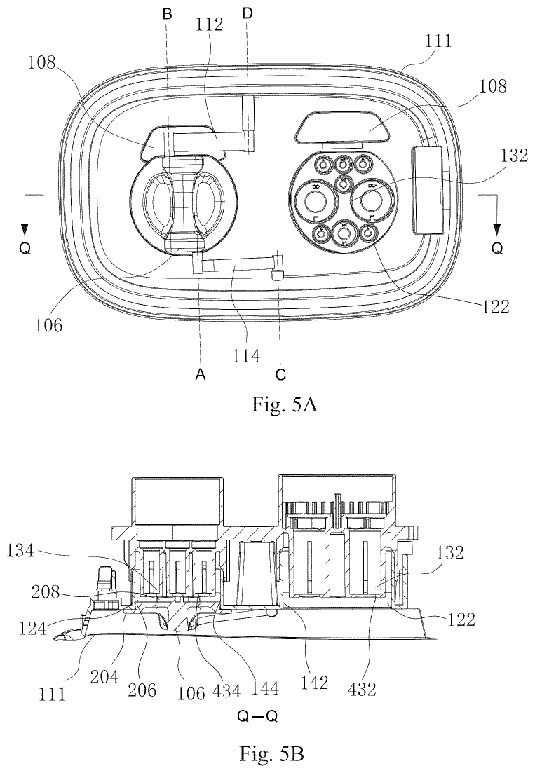

With continued reference to FIGS. 2B and 2C, the inner side end surface of the cover 106 has an inner side wall 210, a part of the material of the inner side wall 210 protrudes outward to form a stop structure 208, and the stop structure 208 can abut against an end portion of the direct-current interface 132 or the alternating-current interface 134, and is configured to position or stop the cover 106 in the axial direction when the cover 106 seals the direct-current charging port 122 or the alternating-current charging port 124 (see FIGS. 4B and 5B for details).

FIGS. 3A, 3B and 3C illustrate a schematic diagram of the cover 106 connected by means of the four link-rods mechanism during the switching of the charging ports. FIG. 3A illustrates a perspective view of the cover 106 in an intermediate position during the switching of the charging ports, FIG. 3B illustrates a top view T of the charging assembly 100 shown in FIG. 3A in this intermediate position, and FIG. 3C illustrates a simplified view of the four link-rods mechanism of the charging assembly 100 shown in FIG. 3B.

As shown in FIGS. 3A and 3B, during the switching of the cover 106 from sealing the direct-current charging port 122 to sealing the alternating-current charging port 124 or from sealing the alternating-current charging port 124 to scaling the direct-current charging port 122, the whole cover 106 is translated outward relative to the charging seat 111 (as shown in FIG. 3B). In the above-mentioned switching process, since the cover 106, the charging seat 111, the upper link rod 112 and the lower link rod 114 form the four link-rods mechanism, the cover 106 is not overturned during the translation, that is, the direct-current sealing portion 204 and the alternating-current sealing portion 206 of the cover 106 always face the direct-current charging port 122 or the alternating-current charging port 124 (an inside direction of the vehicle body 102). In order to further explain the principle of operation of a switching movement of the cover 106, FIG. 3C illustrates a simplified structure of the cover 106, the charging seat 111, the upper link rod 112 and the lower link rod 114, which is shown in a line form.

In FIG. 3C, the cover 106 is simplified and shown as a line segment AB, the charging seat 111 is simplified and shown as a line segment CD, the upper link rod 112 is simplified and shown as a line segment BD, and the lower link rod 114 is simplified and shown as a line segment AC. Since the length of the upper link rod 112 is equal to the length of the lower link rod 114, the length of the line segment BD is equal to the length of the line segment AC. Accordingly, by means of reasonable distance settings, it is possible to set a distance between the pivot axis A and the pivot axis B running through the cover 106 to be equal to a distance between the pivot axis C and the pivot axis D running through the charging seat 111, and therefore the length of the line segment AB is equal to the length of the line segment CD. Thus, the line segment AB, the line segment CD, the line segment AC and the line segment BD can form a parallelogram, the line segment AC and the line segment BD can swing synchronously relative to the line segment AB and the line segment CD, and the line segment AB and the line segment CD always remain parallel to each other during the swing of the line segment AC and the line segment BD. Specifically, in the cover assembly of the present disclosure, the cover 106 is swingable relative to the charging seat 111 by means of the connection of the upper link rod 112 and the lower link rod 114, and during this process, the cover 106 is only translated without rotation (overturning).

In an embodiment of the present disclosure, the cover assembly further comprises an actuator (not shown in the figures). The actuator is provided on the inner side of the charging seat 111 facing the interfaces and is configured to cause the upper link rod 112 or the lower link rod 114 to pivot, or cause the upper link rod 112 and the lower link rod 114 to simultaneously pivot. The actuator can be electrically connected to the master control system of the vehicle (not shown in the figures) in a communicating manner, the actuator can be controlled by the master control system of the vehicle to cause the upper link rod 112 or the lower link rod 114 to pivot, and thus the cover 106 can be controlled to switch back and forth between sealing the direct-current charging port 122 and sealing the alternating-current charging port 124.

In an embodiment of the present disclosure, the direct-current charging port 122 and the alternating-current charging port 124 are further provided with corresponding position sensors (not shown in the figures) that can detect whether the cover 106 is in a position where the direct-current charging port 122 or the alternating-current charging port 124 is sealed, and this position information of the cover 106 is transmitted to the master control system of the vehicle.

Specifically, during a charging operation, if alternating-current charging is required to perform on the vehicle, a user can select an alternating-current charging mode on a master control panel, and the master control system can control the charging seat cover 104 to open, exposing the charging assembly. If the position sensor detects that the cover 106 is in the position where the direct-current charging port 122 is sealed, that is, the alternating-current charging port 124 is in an exposed state, the user can directly connect the charging gun 101 to the alternating-current interface 134, so as to perform the charging operation on the vehicle; and if the position sensor detects that the cover 106 is in the position where the alternating-current charging port 124 is sealed, that is, the direct-current charging port 122 is in an exposed state, the master control system can control the actuator to drive the upper link rod 112 and/or the lower link rod 114 to pivot, thereby moving the cover 106 from the position where the alternating-current charging port 124 is sealed to the position where the direct-current charging port 122 is sealed, thus exposing the alternating-current charging port 124. In this case, the user can connect the charging gun 101 to the alternating-current interface 134, so as to perform the charging operation on the vehicle. The user can also perform direct-current charging on the vehicle in the same way as the above-mentioned operation.

For those of ordinary skill in the art, in some other embodiments, the actuator may be omitted, and the cover 106 can be switched between sealing the direct-current charging port 122 and sealing the alternating-current charging port 124 by means of a manual operation of the user (by holding the hand-held recess portions 211, 212 of the cover 106 with fingers).

FIGS. 4A, 4B, 5A and 5B illustrate use state views of the cover 106 when sealing the direct-current charging port 122 and the alternating-current charging port 124 respectively. FIG. 4A illustrates a front view of the cover 106 in the position where the direct-current charging port 122 is sealed, FIG. 5A illustrates a front view of the cover 106 in the position where the alternating-current charging port 124 is sealed, and FIGS. 4B and 5B are cross-sectional views taken along section lines P-P and Q-Q respectively in FIGS. 4A and 5A to show the stop structure 208 of the cover 106.

As shown in FIGS. 4A and 4B, when the cover 106 is in the position where the direct-current charging port 122 is sealed, the direct-current sealing portion 204 of the cover 106 is in interference fit with the direct-current charging port inner wall 142 of the direct-current charging port 122, thereby coming into contact with the direct-current charging port 122 in a sealed manner. The stop structure 208 of the cover 106 can abut against an end portion 432 of the direct-current interface 132, thereby limiting an axial movement of the cover 106 in the direct-current charging port 122.

As shown in FIGS. 5A and 5B, when the cover 106 is in the position where the alternating-current charging port 124 is sealed, the alternating-current sealing portion 206 of the cover 106 is in interference fit with the alternating-current charging port inner wall 144 of the alternating-current charging port 124, thereby coming into contact with the alternating-current charging port 124 in a sealed manner. The stop structure 208 of the cover 106 can abut against an end portion 434 of the alternating-current interface 134, thereby limiting an axial movement of the cover 106 in the alternating-current charging port 124.

Compared with the prior art, the cover assembly of the present disclosure has the following beneficial technical effects.

First, the two sealing portions of the cover 106 (the direct-current sealing portion 204 and the alternating-current sealing portion 206) in the present disclosure are both provided on the same side of the cover 106 facing a charging interface (the inner side of the vehicle body), so that whether the cover 106 seals the direct-current charging port 122 or the alternating-current charging port 124, none of the two sealing portions will be directly exposed to the external environment of the vehicle (dust, rain, and so on), thereby reducing the risk that the direct-current sealing portion 204 and the alternating-current sealing portion 206 of the cover 106 are contaminated by the external environment, and thus reducing the risk that the direct-current charging port 122 and the alternating-current charging port 124 and charging interface elements inside the charging ports are contaminated.

Second, the four link-rods mechanism, which is formed by the cover 106, the charging seat 111, the upper link rod 112 and the lower link rod 114 in the present disclosure, allows the cover 106 to be only translated without overturning during the switching of the cover 106 from sealing the direct-current charging port 122 to sealing the alternating-current charging port 124 or from sealing the alternating-current charging port 124 to sealing the direct-current charging port 122, such that the side of the cover 106 provided with the sealing portions (the direct-current sealing portion 204 and the alternating-current sealing portion 206) always faces the side of the charging interface (the inner side of the vehicle body) throughout the movement, thereby reducing the risk that the direct-current sealing portion 204 and the alternating-current sealing portion 206 of the cover 106 are contaminated by the external environment during the switching of sealing of the charging ports, and thus reducing the risk that the direct-current charging port 122 and the alternating-current charging port 124 and the charging interface inside the charging ports are contaminated.

Third, the cover 106 of the present disclosure can be controlled to switch between the positions where the direct-current charging port 122 and the alternating-current charging port 124 are sealed, by providing the actuator connected to the master control system of the vehicle to pivot the upper link rod 112 or the lower link rod 114; and meanwhile, the master control system is further configured to control the opening and closing of the charging seat cover 104, so that the user can be prevented from directly touching the entire charging assembly 100 during the charging of the vehicle, thereby improving the convenience and controllability of the charging operation and meeting the need for integrated control of the electric vehicle in the future, and also reducing the risk of an accidental electric shock caused by the user directly touching the charging assembly.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A cover for sealing a charging port comprising:
a cover body having an inner cover side and an outer cover side facing away from each other, the cover body comprising:
a first sealing portion configured to seal a first charging port; and
a second sealing portion configured to seal a second charging port,
wherein the first sealing portion and the second sealing portion are arranged at an outer peripheral direction of the cover body, and the first sealing portion and the second sealing portion are both arranged at the inner cover side of the cover body.

2. The cover of claim 1, wherein the first sealing portion and the second sealing portion are sequentially arranged at the outer peripheral direction of the cover body along a direction from the outer cover side to the inner cover side.

3. The cover of claim 1,
wherein the first sealing portion has a first outer diameter and is configured to seal the first charging port having a first aperture diameter, and
wherein the second sealing portion has a second outer diameter and is configured to seal the second charging port having a second aperture diameter.

4. The cover of claim 3, wherein the first outer diameter of the first sealing portion is different from the second outer diameter of the second sealing portion, and a size of the first aperture diameter of the first charging port is different from a size of the second aperture diameter of the second charging port.

5. The cover of claim 2, wherein the first sealing portion is different from the second sealing portion in shape, and the first charging port is different from the second charging port in shape.

6. The cover of claim 1, further comprising:
a cover pivot upper portion and a cover pivot lower portion, the cover pivot upper portion and the cover pivot lower portion being used to connect the cover to a cover connection assembly,
wherein the cover pivot upper portion has a first pivot axis, and the cover pivot lower portion has a second pivot axis, and
wherein the cover connection assembly is able to be pivotable relative to the cover about the first pivot axis or the second pivot axis.

7. The cover of claim 6, wherein the first pivot axis and the second pivot axis are parallel to each other and the first pivot axis, and the second pivot axis do not coincide with each other.

8. The cover of claim 1, further comprising:
a cover handle arranged on the outer cover side of the cover body.

9. The cover of claim 8, wherein the cover handle comprises two hand-held recess portions recessed towards an inner side of the cover body for facilitating a user to hold the cover.

10. The cover of claim 1,
wherein an inner side wall is provided on an inner side end surface of the cover body, and
wherein the cover further comprises a stop structure which is formed by protruding outwards from the inner side wall.

11. The cover of claim 1, wherein the first charging port is a direct-current charging port, and the second charging port is an alternating-current charging port.

12. The cover of claim 1, wherein the cover is made by one piece through cast molding.

13. A cover assembly comprising:
the cover of claim 1;
a charging seat comprising the first charging port and the second charging port; and
a cover connection assembly configured to movably connect the cover to the charging seat, such that the cover is configured to switchably seal any one of the first charging port and the second charging port.

14. The cover assembly of claim 13, wherein the first aperture diameter of the first charging port is different from the second aperture diameter of the second charging port.

15. The cover assembly of claim 13,
wherein the first sealing portion is configured to be in interference fit with the first charging port so as to seal the first charging port, and
where the second sealing portion is configured to be in interference fit with the second charging port so as to seal the second charging port.

16. The cover assembly of claim 13,
wherein the cover connection assembly comprises an upper link rod and a lower link rod, wherein the upper link rod has an upper link rod first end and an upper link rod second end, and the lower link rod has a lower link rod first end and a lower link rod second end,
wherein the cover comprises a cover pivot upper portion and a cover pivot lower portion,
wherein the charging seat comprises an upper pivot connecting portion and a lower pivot connecting portion,
wherein the upper link rod first end is pivotably connected to the cover pivot upper portion,
wherein the upper link rod second end is pivotably connected to the upper pivot connecting portion,
wherein the lower link rod first end is pivotably connected to the cover pivot lower portion, and
wherein the lower link rod second end is pivotably connected to the lower pivot connecting portion.

17. The cover assembly of claim 16,
wherein the upper link rod first end is configured to pivot about a first pivot axis relative to the cover pivot upper portion,
wherein the lower link rod first end is configured to pivot about a second pivot axis relative to the cover pivot lower portion,
wherein the upper link rod second end is configured to pivot about a third pivot axis relative to the upper pivot connecting portion, and
wherein the lower link rod second end is configured to pivot about a fourth pivot axis relative to the lower pivot connecting portion.

18. The cover assembly of claim 17,
wherein the first pivot axis, the second pivot axis, the third pivot axis and the fourth pivot axis are parallel to each other and the first pivot axis, the second pivot axis, the third pivot axis and the fourth pivot axis do not coincide with each other,
wherein a distance between the first pivot axis and the second pivot axis is the same as a distance between the third pivot axis and the fourth pivot axis, and
wherein the upper link rod and the lower link rod have the same length.

19. The cover assembly of claim 16, wherein the upper link rod, the lower link rod, the cover and the charging seat form a four link-rods mechanism.

20. The cover assembly of claim 16, further comprising:
an actuator configured to drive at least one of the upper link rod and the lower link rod to pivot.
